(19) United States
(12) Patent Application Publication
(10) Pub. No.: US 2026/0105413 A1
(43) Pub. Date: Apr. 16, 2026

(54) WORK ITEM INFORMATION VIEWING METHOD AND APPARATUS, ELECTRONIC DEVICE, AND STORAGE MEDIUMON

(71) Applicant: Beijing Zitiao Network Technology Co., Ltd., Beijing (CN)

(72) Inventors: Hang Ren, Beijing (CN); Kexin Shi, Beijing (CN)

(21) Appl. No.: 19/114,777

(22) PCT Filed: Oct. 10, 2023
(86) PCT No.: PCT/CN2023/123677

§ 371 Date: Mar. 24, 2025

(30) Foreign Application Priority Data
Oct. 10, 2022 (CN) 202211236511.4

(51) Int. Cl. G06Q 10/10

(52) U.S. Cl. CPC G06Q 10/10

(57) ABSTRACT

A work item information viewing method and apparatus, an electronic device, and a storage medium. The method comprises: in response to a work item viewing request for a target work item, obtaining a flowchart of a target business corresponding to the target work item; and displaying at least a partial region of the flowchart in a work item detail page corresponding to the work item viewing request.

### CROSS-REFERENCE TO RELATED APPLICATION(S)

The present application claims priority to Chinese Patent Application No. 202211236511.4, filed with the China National Intellectual Property Administration on Oct. 10, 2022, the disclosure of which is hereby incorporated by reference in its entirety.

### FIELD

Embodiments of the present disclosure relate to data processing technologies, and for example, to a method and apparatus for viewing work item information, an electronic device, and a storage medium.

### BACKGROUND

In a project management scenario, a user may view details of a work item by accessing a work item detail page, so as to assist in project management.

### SUMMARY

The present disclosure provides a method and apparatus for viewing work item information, an electronic device and a storage medium.

According to a first aspect, embodiments of the present disclosure provides a method for viewing work item information. The method includes:

in response to a work item viewing request for a target work item, obtaining a flowchart of a target business corresponding to the target work item; and displaying at least a partial region of the flowchart in a work item detail page corresponding to the work item viewing request.

According to a second aspect, embodiments of the present disclosure further provides an apparatus for viewing work item information. The apparatus includes:
a viewing request module configured to, in response to a work item viewing request for a target work item, obtain a flowchart of a target business corresponding to the target work item; and
a page display module configured to display at least a partial region of the flowchart in a work item detail page corresponding to the work item viewing request.

According to a third aspect, embodiments of the present disclosure further provides an electronic device. The electronic device includes:
one or more processors; and
a storage configured to store one or more programs, wherein
the one or more programs, when executed by the one or more processors, cause the one or more processors to implement the method for viewing work item information of any of the embodiments of the present disclosure.

According to a fourth aspect, embodiments of the present disclosure further provides a storage medium containing computer-executable instructions that, when executed by a computer processor, are configured to perform the method for viewing work item information of any of the embodiments of the present disclosure.

### BRIEF DESCRIPTION OF THE DRAWINGS

Throughout the drawings, the same or similar reference numerals indicate the same or similar elements. It is to be understood that the drawings are schematic and that parts and elements are not necessarily drawn to scale.

FIG. 1 is a schematic flowchart of a method for viewing work item information according to embodiments of the present disclosure;

FIG. 2 is a schematic diagram of a work item detail page and a flowchart display according to embodiments of the present disclosure;

FIG. 3 is a schematic flowchart of another method for viewing work item information according to embodiments of the present disclosure;

FIG. 4 is a comparison diagram of layout effects of a work item detail page when summary information of a selected node is displayed and when the summary information of the selected node is not displayed according to embodiments of the present disclosure;

FIG. 5 is a schematic flowchart of yet another method for viewing work item information according to embodiments of the present disclosure;

FIG. 6 is a schematic structural diagram of an apparatus for viewing work item information according to embodiments of the present disclosure; and

FIG. 7 is a schematic structural diagram of an electronic device according to embodiments of the present disclosure.

### DETAILED DESCRIPTION OF EMBODIMENTS

In the related art, for the display of a business process in the method for viewing work item information, especially in a mobile terminal application, for example, a serial process in an approval scenario, focus is usually placed on the display of a specific task node and a few related roles, such that users can view limited information, especially for a complex workflow involving multiple tasks and multiple roles, it is difficult for users to understand global information, so the user experience is affected.

In view of the above, embodiments of the present disclosure disclose a method, apparatus, an electronic device, and a storage medium for viewing work item information.

Embodiments of the present disclosure are described in more detail below with reference to the accompanying drawings. Although some embodiments of the present disclosure are shown in the drawings, it is to be understood that the present disclosure may be implemented in various forms and should not be construed as being limited to the embodiments set forth herein. Rather, these embodiments are provided for a more thorough and complete understanding of the present disclosure. It is to be understood that the drawings and embodiments of the present disclosure are only for exemplary purposes, and are not intended to limit the scope of protection of the present disclosure.

It is to be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It is to be noted that concepts such as “first” and “second” mentioned in the present disclosure are only used to distinguish different apparatuses, modules, or units, and are not used to limit the sequence of functions performed by these apparatuses, modules, or units or interdependence.

It is to be noted that the modifiers “one” and “a plurality of” mentioned in the present disclosure are illustrative and not restrictive, and those skilled in the art should understand that unless the context clearly indicates otherwise, it is to be understood as “one or more”.

The names of messages or information exchanged between a plurality of apparatuses in the implementation of the present disclosure are used for illustrative purposes only, and are not used to limit the scope of these messages or information.

It is to be understood that before using each embodiment of the present disclosure, the user can be informed of the type, scope of use, and use scenario of personal information involved in the present disclosure in an appropriate manner in accordance with relevant laws and regulations, and the user's authorization will be obtained.

For example, when a user's active request is received, prompt information is sent to the user to explicitly prompt the user that the operation requested by the user will need to obtain and use the user's personal information. Therefore, the user can independently choose whether to provide personal information to software or hardware such as an electronic device, an application, a server, or a storage medium that executes the operation in the embodiments of the present disclosure according to the prompt information.

As an optional but non-limiting implementation, the manner of sending prompt information to the user in response to receiving the user's active request may be, for example, in a pop-up window, and the prompt information may be presented in the pop-up window in text. In addition, the pop-up window may also carry a selection control for the user to select “agree” or “disagree” to provide personal information to the electronic device.

It is to be understood that the above notification and user authorization process are only schematic and do not limit the implementation of the present disclosure, and other manners that meet relevant laws and regulations may also be applied to the implementation of the present disclosure.

It is to be understood that the data involved in the embodiments (including but not limited to the data itself, the acquisition or use of the data) should comply with the requirements of corresponding laws, regulations and related regulations.

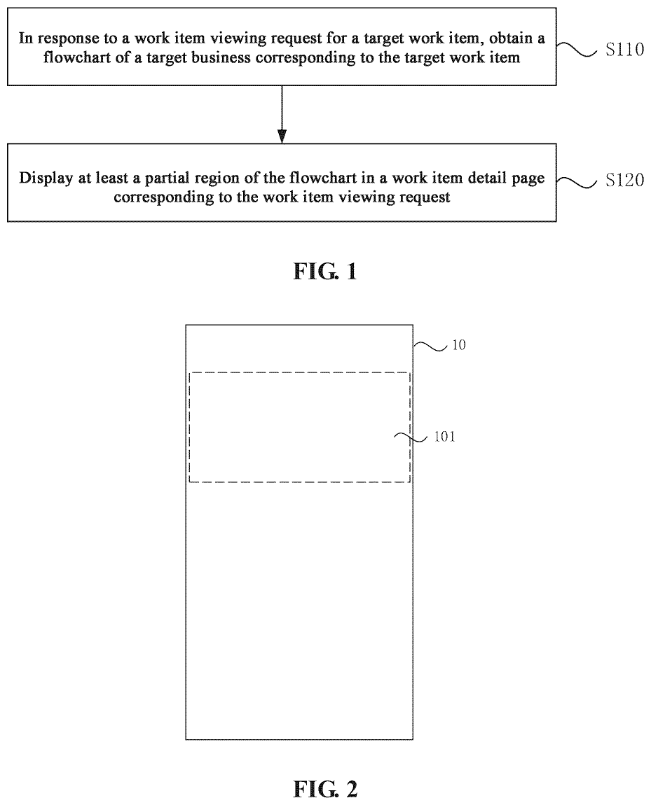

FIG. 1 is a schematic flowchart of a method for viewing work item information according to embodiments of the present disclosure. The method for viewing work item information in the embodiments of the present disclosure may be used to display a whole workflow in a work item detail viewing scenario, which is especially suitable for a complex workflow involving multiple tasks or multiple roles, and which is especially suitable for application in a mobile terminal. The method may be performed by an apparatus for viewing work item information, which may be implemented in the form of software and/or hardware, for example, by an electronic device, which may be a mobile terminal, a personal computer (PC) terminal, a server, or the like.

As shown in FIG. 1, the method in this embodiment may include the following steps.

S110: in response to a work item viewing request for a target work item, obtain a flowchart of a target business corresponding to the target work item.

The target business may include one or more business work items. A work item may be understood as a sub-business in the target business, or a sub-process in a target business process. The work item may include one or more nodes in the target business that are associated with the work item. The target work item may be understood as a business work item requested by an authorized user for viewing. The flowchart of the target business may be constructed in advance, and generally may include each node related to the target business and a logical relationship between each node. The logical relationship at least may include an execution sequence of each node.

The work item viewing request may be understood as a request for viewing work item details initiated for the target work item. In order to ensure information security, the work item viewing request for the target work item may be, for example, in response to a work item viewing request for the target work item from an authorized user. The authorized user may be understood as a user who has been granted the right to view work item information of the target work item.

In this embodiment of the present disclosure, the work item viewing request for the target work item may be initiated based on an interaction operation, for example, a control trigger operation for a preset work item viewing control is received, or an identifier trigger operation for a work item identifier of the target work item is received, or a page opening operation for opening a work item detail page of the target work item is received.

In this embodiment of the present disclosure, an association relationship between the target work item and the flowchart of the target business may be established in advance. Correspondingly, obtaining the flowchart of the target business corresponding to the target work item may be obtaining the flowchart of the target business corresponding to the target work item based on the target work item and the association relationship.

In a case that there are a plurality of flowcharts of the target business corresponding to the target work item, the flowchart of the target business corresponding to the target work item may be obtained based on version information or an update time of the flowchart. For example, a flowchart of the latest version of the target business corresponding to the target work item may be obtained. Alternatively, identifiers of all versions of the flowchart corresponding to the target business which corresponds to the target work item may be displayed, a selection operation for the identifiers is received, and a flowchart corresponding to a selected identifier is used as the flowchart of the target business corresponding to the target work item.

S120: display at least a partial region of the flowchart in a work item detail page corresponding to the work item viewing request.

For example, the work item detail page of the target work item may be a work item detail page of a business requirement, a work item detail page of a business defect, or a work item detail page of a process version iteration. It is to be understood that in the embodiments of the present disclosure, in addition to displaying the flowchart of the target business, the work item detail page of the target work item may also display other information related to the target work item. For example, it may be execution information of the target work item by the authorized user, or details of a pending node corresponding to the authorized user.

In view of the limited display space of the flowchart in the work item detail page and the different complexities of the flowchart, the flowchart may be displayed in the work item detail page corresponding to the work item viewing request according to a preset flowchart display manner. The at least partial region of the flowchart includes the entire region of the flowchart and a partial region of the flowchart. For example, the display of the flowchart may be adapted to a terminal. A manner in which the flowchart is adapted to the terminal may be set according to actual requirements, which is not specifically described here.

For example, the at least partial region of the flowchart may be displayed in the work item detail page corresponding to the work item viewing request based on a first preset position. for example, the first preset position may include a top position, a middle position, or a bottom position of the work item detail page. As shown in FIG. 2, the at least partial region of the flowchart may be displayed at a top position 101 of the work item detail page 10 corresponding to the work item viewing request. The advantage of this setting is that the flowchart can be kept conspicuous and can be well adapted to the terminal to optimize the layout of the work item detail page.

In this embodiment of the present disclosure, the partial region of the flowchart may be displayed in the work item detail page corresponding to the work item viewing request by default. for example, the node processing status of each node in the flowchart may be obtained, and the partial region of the flowchart is displayed in the work item detail page corresponding to the work item viewing request according to the processing status.

For example, the node processing status may include a pending node. The partial region of the flowchart is displayed in the work item detail page corresponding to the work item viewing request with a pending node with the highest processing sequence (the first one) as the center. The pending node with the highest processing sequence may be, according to the structure of the flowchart, the first pending node from left to right and from top to bottom in the flowchart.

For example, the node processing status may include an in-progress node. For example, in a case that there is no pending node in the flowchart, the partial region of the flowchart is displayed in the work item detail page corresponding to the work item viewing request with the last in-progress node as the center.

For example, the node processing status may further include a completed node. When all nodes in the flowchart are completed, the flowchart may be located at the last completed node and displayed in the work item detail page corresponding to the work item viewing request.

For example, the node processing status of each node may be distinguished through an enlarged node status indicator in the flowchart, which is intuitive and understandable.

For the flowchart displayed in the work item detail page, the default zoom scale of the flowchart may be 100%.

In order to facilitate the authorized user to view details of the flowchart, summary information of each node in the flowchart may be viewed. As an example of the embodiments of the present disclosure, the method for viewing work item information may further include: receiving a node selection operation for at least one node in the flowchart, and displaying summary information of the selected node in the work item detail page. The advantage of this setting is that compared with the manner of identifying and displaying node information in the flowchart, the summary information of the node can be displayed by triggering the node in the flowchart, such that the authorized user can understand the general overview of each node in the business process, and can support the authorized user to view global information.

The node selection operation may be understood as a trigger operation for selecting a node.

For example, receiving the node selection operation for the at least one node in the flowchart may be receiving a node trigger operation for the at least one node in the flowchart. For example, it may be an operation of clicking on a node in the flowchart.

For example, displaying the summary information of the selected node in the work item detail page includes: displaying the summary information of the selected node in the form of a bubble or a pop-up window in the work item detail page corresponding to the selected node in the flowchart; or displaying the summary information of the selected node in the work item detail page based on a second preset position. The second preset position may be a position in the work item detail page adjacent to a display position of the flowchart.

As another example of the embodiments of the present disclosure, the method for viewing work item information may further include: in response to a display adjustment operation for the flowchart, adjusting a display manner of the flowchart in the work item detail page, wherein the display manner includes a display size and a display region.

The display adjustment operation may be understood as a trigger operation for adjusting the display manner of the flowchart. The display size may be understood as a size of a page region occupied by the flowchart in the work item detail page, and/or an enlargement or reduction of content of the flowchart itself. The display region may be understood as a page region displayed by the flowchart in the work item detail page, that is, a visualization region of the flowchart.

For example, the display adjustment operation for the flowchart may be a click (a single-click or double-click) operation for the flowchart, or a drag operation for the flowchart, or a control trigger operation for a preset flowchart adjustment control, or a preset touch operation for the flowchart. The preset touch operation includes at least a touch position and/or a touch manner. Further, the touch manner may be a preset touch trajectory or a preset gesture.

For example, the drag operation for the flowchart may be a drag operation for a preset trigger point. It is to be noted that there may be one or more preset trigger points. Further, dragging different preset trigger points may adjust the display size of the flowchart in different manners. Typically, the preset trigger point may be arranged at a center point or a vertex of a boundary of the page region occupied by the flowchart in the work item detail page.

In addition, the drag operation for the flowchart may be a drag operation for the display region of the flowchart. For example, it may be in response to the drag operation for the display region of the flowchart, adjusting the display region of the flowchart in the work item detail page based on the drag operation. In other words, content visualized by the flowchart may be changed by dragging the flowchart.

For example, adjusting the display region of the flowchart in the work item detail page based on the drag operation may be, for example, adjusting the display region of the flowchart in the work item detail page according to an action position of the drag operation in the flowchart and a drag distance. The advantage of this setting is that even if the work item detail page fails to display the complete flowchart, the authorized user can view content which is not displayed in the flowchart through a simple interaction operation, which is convenient to operate and makes the information viewing more intelligent and more suitable for user requirements.

For example, when the display manner of the flowchart in the work item detail page is adjusted through the control trigger operation for the preset flowchart adjustment control, a correspondence between the flowchart adjustment control and the display manner of the flowchart in the work item detail page, or a correspondence between a trigger manner of the flowchart adjustment control and the display manner of the flowchart in the work item detail page may be preset. Further, the display manner of the flowchart in the work item detail page may be adjusted based on the correspondence in response to the control trigger operation for the preset flowchart adjustment control.

In this embodiment of the present disclosure, the flowchart may be created based on a preset template. When the template is updated, the flowchart to which the template is applied may be updated in an automatic or manual manner. As an example of the embodiments of the present disclosure, the method for viewing work item information may further include: receiving a template update operation input for the flowchart, obtaining an update template corresponding to the flowchart, and updating the flowchart based on the update template. The advantage of this setting is that the display style of the flowchart can be updated to support diversified display of the flowchart, thereby meeting the personalized visualization requirements of users.

The template update operation may be understood as a trigger operation for displaying the flowchart using the updated template.

For example, receiving the template update operation input for the flowchart includes: a control trigger operation for a preset template update control. When the control trigger operation for the preset template update control is received, the latest template corresponding to the flowchart is obtained as the update template. Exemplarily, whether the template is the latest template may be determined based on a version number or editing time of the template. In a case that there is no updatable template, the template update control may be set to an inoperable state. When the template update control is set to the inoperable state, if the control trigger operation for the preset template update control is received, prompt information for indicating that there is no template to be updated is generated.

For example, receiving the template update operation input for the flowchart includes: receiving a template viewing operation input for the flowchart, and displaying at least one template; and receiving a selection operation for the at least one template, and using a selected template as the update template corresponding to the flowchart.

Further, after receiving the template update operation input for the flowchart, inquiry information for inquiring whether to update the template may be generated. In a case that a confirmation trigger operation for the inquiry information is received, the update template corresponding to the flowchart is obtained, and the flowchart is updated based on the update template. The inquiry information for inquiring whether to update the template includes update confirmation information and associated prompt information. For example, the inquiry information for inquiring whether to update the template may be: “Are you sure to upgrade the XX to the latest template? Nodes may be added or deleted after upgrading, and cannot be rolled back.”

For example, updating the flowchart based on the update template may be updating, based on each node in the flowchart and a logical relationship between each node, each node in the flowchart into the update template.

In the embodiments of the present disclosure, in response to a work item viewing request for a target work item, a flowchart of a target business corresponding to the target work item is obtained. Compared with a manner of obtaining and displaying only user operation node information in the related art, the obtaining of the flowchart of the target business is added, such that the obtained association information related to the target work item is more comprehensive. At least a partial region of the flowchart is displayed in a work item detail page corresponding to the work item viewing request. The flowchart of the target business can be viewed in the work item detail page, such that the content that can be viewed by the authorized user is increased, and the whole process information associated with the target work item is provided, such that the display form and the display content of the work item information are more enriched, thereby improving the user experience.

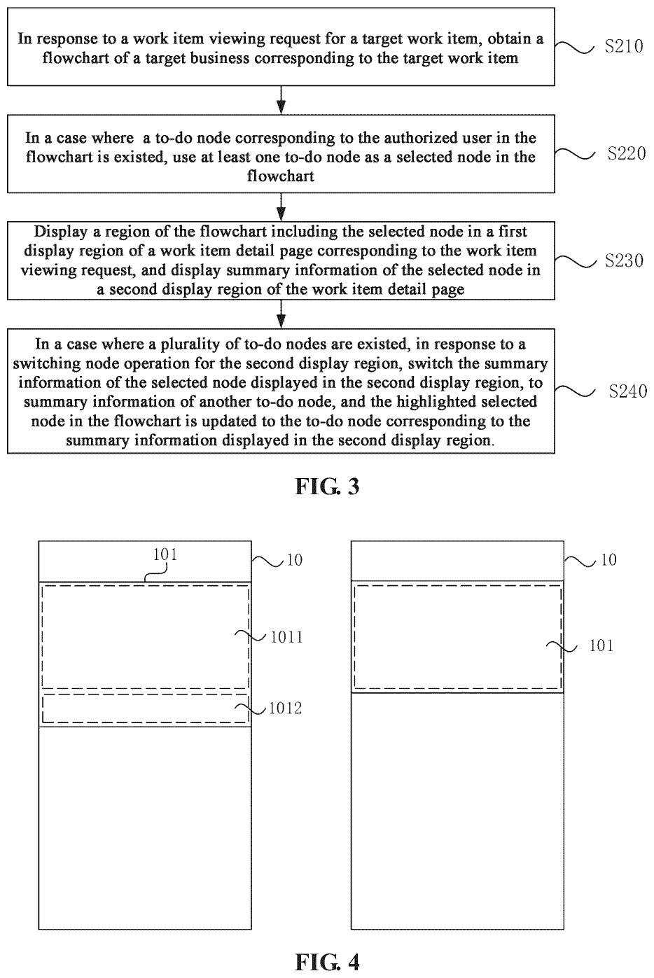

FIG. 3 is a schematic flowchart of another method for viewing work item information according to embodiments of the present disclosure. Based on the above embodiments, this embodiment further refines how to display the flowchart in the work item detail page. For example, the displaying at least a partial region of the flowchart in a work item detail page corresponding to the work item viewing request includes: in a case that there is a pending node corresponding to the authorized user in the flowchart, using at least one pending node as a selected node in the flowchart; and displaying a region of the flowchart including the selected node in a first display region in the work item detail page corresponding to the work item viewing request, and displaying summary information of the selected node in a second display region in the work item detail page. For a specific implementation manner, reference may be made to the description of this embodiment. Technical features the same as or similar to those in the foregoing embodiments are not described again here.

As shown in FIG. 3, the method in this embodiment may include the following steps.

S210: in response to a work item viewing request for a target work item, obtain a flowchart of a target business corresponding to the target work item.

S220: in a case that there is a pending node corresponding to the authorized user in the flowchart, use at least one pending node as a selected node in the flowchart.

In this embodiment of the present disclosure, the authorized user may be understood as a user who requests to view work item information of the target work item, or may be a user who initiates the work item viewing request and has the permission to view work item information. The pending node may be understood as a node that has not been processed and is to be processed by the authorized user.

It may be understood that there may be one or more pending nodes corresponding to the authorized user. Therefore, in a case that there is a pending node corresponding to the authorized user in the flowchart, one or more pending nodes may be used as the selected node in the flowchart.

As an example of the embodiments of the present disclosure, using at least one pending node as the selected node in the flowchart may be using all pending nodes as the selected node in the flowchart, or may be using a selected number of pending nodes as the selected node in the flowchart.

For example, in a case that there are a plurality of pending nodes corresponding to the authorized user in the flowchart, the selected node in the flowchart may be determined based on a processing sequence corresponding to each pending node. Exemplarily, a pending node with the highest processing sequence is used as the selected node in the flowchart.

S230: display a region of the flowchart including the selected node in a first display region in the work item detail page corresponding to the work item viewing request, and display summary information of the selected node in a second display region in the work item detail page.

In order to facilitate the user to view the pending node intuitively, the selected node may be highlighted in the flowchart. There may be many manners of highlighting, for example, highlighting a node identifier in a manner of color, font, font size, adding an underline, or blinking. There may be a plurality of identifier manners of the node identifier, for example, text and/or graphics.

The first display region may be understood as a region in which the flowchart is displayed. The flowchart may cover the entire first display region, or may occupy a partial region of the first display region. The second display region may be understood as a region for displaying the summary information of the selected node. The summary information of the selected node may include one or more items of sub-information. Further, each item of sub-information may be arranged in the second display region in a preset manner. It is to be noted that the first display region and the second display region may be two independent regions in the work item detail page. The second display region may also be a sub-region in the first display region.

In this embodiment of the present disclosure, in a case that there is the selected node in the flowchart, the region of the flowchart including the selected node may be displayed in the first display region in the work item detail page corresponding to the work item viewing request, and the summary information of the selected node may be displayed in the second display region in the work item detail page. In a case that there is no selected node in the flowchart or all nodes in the flowchart are completed nodes, only the flowchart may be displayed in the work item detail page corresponding to the work item viewing request, and the summary information of the node is not displayed. In this case, the second display region may be hidden.

For example, the size of the first display region is adjusted according to whether the summary information of the selected node is displayed. In other words, the size of the first display region may be dynamically adjusted according to whether there is a second display region.

Exemplarily, as shown in the left diagram of FIG. 4, in the work item detail page 10, the flowchart may occupy a partial region 1011 of the first display region 101. In a case that there is the selected node in the flowchart, the first display region 101 may be expanded downward to display a second display region 1012, and the summary information of the selected node is displayed in the second display region 1012 in the work item detail page. In a case that there is no selected node in the flowchart, as shown in the right diagram of FIG. 4, the second display region 1012 in the first display region 101 may be hidden, and the first display region 101 is folded. The advantage of this setting is that the page layout of the work item detail page can be dynamically adjusted, and linkage between the flowchart and the node summary information is implemented through linkage between the first display region 101 and the second display region 1012, thereby avoiding waste of page space, optimizing page resource configuration, and displaying more information as possible. For example, details of the selected node displayed in the second display region 1012 or details of other nodes by default are displayed in a lower region of the work item detail page 10 than the first display region 101.

Further, a detail viewing trigger operation for the summary information of the selected node is received, and details of the selected node are displayed. In this embodiment of the present disclosure, the flowchart itself may also be used as an index to jump to details of all nodes. For example, a node detail viewing operation for the flowchart may be received, and details of a node to be viewed are displayed. For example, details of a node in the flowchart are displayed by double-clicking on or long-pressing the node. The node to be viewed may be understood as a node on which the node detail viewing operation acts.

For example, the details of the node may be displayed in the work item detail page in the form of a bubble or a pop-up window, or may be displayed by jumping to a node detail page.

S240: in a case that there are a plurality of pending nodes, in response to a node switching operation for the second display region, switch the summary information of the selected node displayed in the second display region to summary information of another pending node, and update the selected node highlighted in the flowchart to a pending node corresponding to the summary information displayed in the second display region.

The node switching operation may be understood as an operation for switching a selected node. In this embodiment, the node switching operation particularly includes an operation for switching the selected node by triggering the second display region.

For example, the node switching operation for the second display region includes a control trigger operation for a preset node switching control corresponding to the second display region, wherein the node switching control may include a first switching control for switching to a previous pending node and a second switching control for switching to a next pending node. Exemplarily, the first switching control and the second switching control may be respectively arranged at the left and right ends inside or outside the second display region. Further, identifiers of the first switching control and the second switching control may be used to indicate a switching direction of the node. For example, arrow identifiers in different directions may be used.

For example, the node switching operation for the second display region includes a sliding operation for the second display region. Similarly, the sliding operation may include two manners of sliding leftward and sliding rightward, or may further include two manners of sliding upward and sliding downward, wherein different sliding directions are used to indicate different node switching directions.

For example, when the summary information of the selected node displayed in the second display region is switched to summary information of another pending node, the selected node highlighted in the flowchart may be automatically updated to the pending node corresponding to the summary information displayed in the second display region, thereby implementing linkage between the flowchart and the summary information of the selected node.

In view of the fact that the pending node is often a node currently to be processed by the authorized user, in order to facilitate the user to view the pending node, quick positioning of the pending node in the flowchart may be realized by a reset trigger operation, so as to save the labor cost of searching. For example, the method for viewing work item information may further include: receiving a reset trigger operation for a first control in the work item detail page, and displaying a region of the flowchart including the pending node in the first display region and displaying summary information of the pending node displayed in the first display region in the second display region.

The first control may be understood as a control for quickly and associatively positioning the flowchart and the summary information to the pending node. In this embodiment of the present disclosure, the first control may be a virtual control element arranged in the work item detail page. Exemplarily, the first control may be arranged opposite to the second display region. For example, both the second display region and the first control may be arranged in the first display region. The first control may be arranged between the display region of the flowchart and the second display region. The first control may also be arranged in an edge region of the first display region, for example, in an upper-left corner region, an upper-right corner region, or a lower-right corner region of the first display region. Exemplarily, there may be various manifestations of the first control, for example, a text card or a picture.

The reset trigger operation may be understood as a trigger operation for triggering the first control to generate an instruction for quickly and associatively positioning the flowchart and the summary information to the pending node. The reset trigger operation may be a click operation, a drag operation, a slide operation, or a press operation for the first control.

For example, when the reset trigger operation for the first control in the work item detail page is received, the visualization region of the flowchart in the first display region may be switched to the region including the pending node, and the summary information in the second display region may be switched to summary information of the pending node displayed in the first display region.

It is to be noted that the pending node corresponding to the reset trigger operation may be preset, which is not specifically limited here. For example, a pending node with the highest processing sequence in pending nodes of the authorized user is associated with the first control as a node to be reset.

In this embodiment, in a case that there is a pending node corresponding to the authorized user in the flowchart, at least one pending node is used as the selected node in the flowchart. In view of the fact that the pending node corresponding to the authorized user can visually reflect the work progress of the authorized user, information of concern to the user can be accurately located. Further, the region of the flowchart including the selected node is displayed in the first display region in the work item detail page, and the selected node is highlighted in the flowchart, such that the summary information of the selected node can be visually displayed in the second display region in the work item detail page, and the summary information of the selected node is displayed in an additional manner, such that the user can understand more business information through interaction with the flowchart.

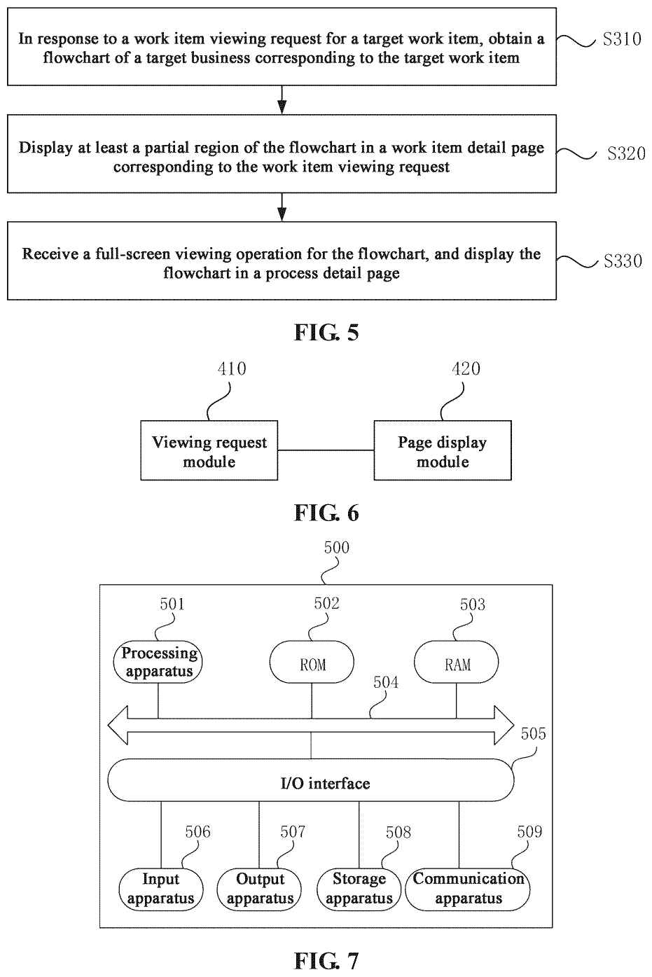

FIG. 5 is a schematic flowchart of still another method for viewing work item information according to embodiments of the present disclosure. Based on the above embodiments, this embodiment adds a technical feature of viewing details of the flowchart. For example, the method further includes: receiving a full-screen viewing operation for the flowchart, and displaying the flowchart in a process detail page. For a specific implementation manner, reference may be made to the description of this embodiment. Technical features the same as or similar to those in the foregoing embodiments are not described again here.

As shown in FIG. 5, the method in this embodiment may include the following steps.

S310: in response to a work item viewing request for a target work item, obtain a flowchart of a target business corresponding to the target work item.

S320: display at least a partial region of the flowchart in a work item detail page corresponding to the work item viewing request.

S330: receive a full-screen viewing operation for the flowchart, and display the flowchart in a process detail page.

The full-screen viewing operation may be understood as a trigger operation for switching a manner of displaying the flowchart in a partial page region of the work item detail page to a full-screen display in the process detail page. For example, the full-screen viewing operation for the flowchart includes a control trigger operation for a preset full-screen control, or a pull-down operation for the flowchart.

In a case that the full-screen viewing operation for the flowchart is received, the flowchart may be displayed in the process detail page. For example, in a case that the flowchart is a landscape flowchart and the terminal device is in a portrait screen state, or in a case that the flowchart is a portrait flowchart and the terminal device is in a landscape screen state, the flowchart may be displayed in a middle region of the process detail page. In a case that the flowchart is a portrait flowchart and the terminal device is in a portrait screen state, or in a case that the flowchart is a landscape flowchart and the terminal device is in a landscape screen state, the flowchart may cover the entire process detail page. In this embodiment of the present disclosure, when a terminal screen state changes, a display manner of the flowchart may be switched according to the above principles, to facilitate the user to view the flowchart.

Exemplarily, the manner of displaying the flowchart in the process detail page may be switching or jumping from the work item detail page to the process detail page to display the flowchart in the process detail page, or expanding a flowchart display region of the work item detail page to generate the process detail page and displaying the flowchart in the process detail page.

In this embodiment of the present disclosure, more operations may be performed on the flowchart in the process detail page to respond to more functional requirements of the authorized user. For example, the method for viewing work item information further includes: receiving a node editing operation for a node in the flowchart, and in response to determining that the authorized user has an editing permission, editing the node corresponding to the node editing operation in the flowchart. The advantage of this setting is that the flowchart can be edited, and permission is set for node editing, such that while the authorized user is responded to editing of the node, misoperation of the authorized user can be effectively prevented, thereby improving the user experience.

The node editing operation may be understood as an operation for editing a node in the flowchart. The node editing operation at least includes a node deletion operation and a node addition operation. Further, the node editing operation may further include an editing operation for summary information of the node or identifier information of the node.

In order to ensure the accuracy and convenience of the operation, receiving the node editing operation for the node in the flowchart may include: receiving a node editing trigger operation for at least one node in the flowchart. For example, a selection operation for a node in the flowchart may be received first, and then an editing operation input for the selected node is received. For example, an operation of dragging the selected node to a preset deletion position may be received. Alternatively, when the selected node is long-pressed or a cursor hovers over the selected node, an edit option corresponding to the node is displayed, and then an edit selection operation for the edit option is received, to perform an edit operation corresponding to the selected edit option on the node.

Exemplarily, the node is long-pressed, and a node deletion entry is provided in the form of a bubble. In response to determining that the authorized user has a deletion permission, the bubble text is “delete”, and if a click operation of the user for the bubble is received, the node is deleted. In order to prevent the user from misoperation, after the click operation of the user for the bubble is received and before the node is deleted, inquiry information for inquiring whether the authorized user deletes the node may be displayed, for example, “Are you sure to delete this node? After deleting, the node may be restored by ”Restore Deleted Node“”. After the confirmation trigger operation for the inquiry information is received, the node is deleted. On this basis, an entry for entering a deletion reason may also be displayed for the user to enter the deletion reason. After the node is deleted successfully, prompt information for prompting the authorized user of the successful deletion may be generated and displayed. When the authorized user does not have the permission to delete the node or the node cannot be deleted, the bubble text may be displayed as “not deletable”, and is displayed as an inoperable state.

For example, receiving the node editing operation for the node in the flowchart includes: receiving a control trigger operation for a second control in the process detail page, wherein the second control is associated with at least one node in the flowchart.

The second control may be understood as a control for editing a node in the flowchart. The control trigger operation for the second control may be understood as a trigger operation for triggering the second control to generate an instruction for editing the node in the flowchart. One or more second controls may be arranged in the process detail page. The second control may be associated with one or more nodes in the flowchart. In other words, triggering one second control may edit only one node in the flowchart, or may edit a plurality of nodes.

Exemplarily, the second control may be an associated role control and/or a process switch control of the flowchart. The associated role control may be understood as a control corresponding to a role associated with each node in the flowchart. The process switch control may be understood as a control corresponding to each sub-process included in the flowchart, and each sub-process may correspond to one or more nodes in the flowchart.

Exemplarily, the associated role control may be tiled and displayed in the process detail page, and an authorized user with the editing permission may select to add or delete one or more associated roles through the associated role control. In a case that a control trigger operation for the associated role control is received, edit association information is displayed, for example, inquiry information of “The following nodes will be added/deleted in this operation: node 1, node 2, . . . , are you sure to add/delete this role?” is displayed. In a case that an edit confirmation trigger operation for the inquiry information is received, the flowchart is accordingly cropped (dynamically adjusted) according to a node editing manner corresponding to the associated role control. It may be understood that, in a case that an edit cancellation trigger operation for the inquiry information is received, the current edit may be exited.

Exemplarily, the process switch control may be tiled and displayed in the process detail page, and the authorized user may add or delete one or more process nodes by enabling or disabling any process switch control that is operable with permission. Similarly, in a case that a control trigger operation for the process switch control is received, edit association information is displayed, for example, inquiry information of “The following nodes will be added/deleted in this operation: node 1, node 2, . . . , are you sure to continue to modify?” is displayed. In a case that an edit confirmation trigger operation for the inquiry information is received, the flowchart is accordingly cropped (dynamically adjusted) according to a node editing manner corresponding to the process switch control. It may be understood that in a case that an edit cancellation trigger operation for the inquiry information is received, the current edit may be exited.

In a case that the authorized user does not have the editing permission, the second control may be displayed in an uneditable style. In a case that the second control is displayed in the uneditable style, if a control trigger operation of the authorized user for the second control is received, prompt information for indicating that the authorized user does not have the editing permission or the second control cannot be edited is displayed.

In view of the fact that there is often a certain association logic between each node in the flowchart, in this embodiment of the present disclosure, the node corresponding to the node editing operation in the flowchart may be edited based on the association logic between each node.

In this embodiment of the present disclosure, receiving the node editing operation for the node in the flowchart may further include: a restore trigger operation for a deleted node in the flowchart, to restore the deleted node. This embodiment supports single or batch restoration of deleted nodes in the flowchart.

A node restore operation for the node in the flowchart is received, and in response to determining that the authorized user has a restore permission, the node corresponding to the node editing operation in the flowchart is restored.

For example, a node restore operation for the node in the flowchart is received, and in response to determining that the authorized user has a restore permission, a multi-choice component pops up in a half window, and a list of all deleted nodes that can be restored (including a deletion reason) is displayed. After the list of deleted nodes is checked, the user clicks “Finish” to exit. After exiting, the flowchart is adjusted according to the checked nodes.

In the list of deleted nodes that can be restored, a node that cannot be restored by the authorized user is displayed in an inoperable style. If a node restore operation of the authorized user is received, prompt information for indicating that the authorized user temporarily has no restore permission may be generated.

In a case that there is no deleted node that can be restored or the authorized user has no permission to restore all deleted nodes, an entry for restoring a deleted node is displayed in an inoperable style. If a node restore operation of the authorized user is received, prompt information for indicating that there is no restorable node for the authorized user may be generated.

For example, the method for viewing work item information further includes: receiving a positioning trigger operation for a third control in the process detail page, and displaying a target display region of the flowchart in the process detail page.

The third control may be understood as a control for setting a target display region of the flowchart to a visualization state. The positioning trigger operation may be understood as a trigger operation for acting on the third control to enable the third control to generate an instruction for setting the target display region of the flowchart to the visualization state. The target display region may be understood as a region in the flowchart to be converted into the visualization state, for example, a region associated with the third control in advance. Exemplarily, the target display region may be a region including a start node of the flowchart or a region including an end node of the flowchart. For example, the target display region includes the region of the flowchart including the selected node.

Exemplarily, the third control may be a blank region of the process detail page, or may be a positioning control (for example, a control identified by a compass icon) arranged in the process detail page. Correspondingly, the positioning trigger operation for the third control in the process detail page may be a double-click operation for the blank region of the process detail page, or a click operation for the compass icon.

For example, after entering the process detail page, for example, a double-click operation for the blank region of the process detail page is received, the entire flowchart is centered and displayed, and a zoom scale of the flowchart is set to 100%.

For example, the double-click operation for the blank region of the process detail page is received. In a case that the flowchart is zoomed to display all processes and does not reach a preset proportion, all processes of the flowchart are displayed.

For example, the double-click operation for the blank region of the process detail page is received. In a case that the flowchart is zoomed to reach the preset proportion and does not display all processes, for the flowchart with the preset proportion, a middle position of the flowchart is intercepted for display based on longitudinal arrangement and transverse arrangement of the flowchart.

In this embodiment of the present disclosure, a slide operation for the flowchart may also be received to support slide viewing of the flowchart. Further, in the process detail page, a pinch gesture for the flowchart may also be responded to, to reduce the flowchart. An expand gesture for the flowchart may also be responded to, to enlarge the flowchart.

For example, before the positioning trigger operation for the third control in the process detail page is received, the method for viewing work item information further includes: in a case that there is the selected node in the flowchart and the selected node is not displayed in the work item detail page, displaying the third control in the process detail page. Further, displaying the target display region of the flowchart in the process detail page includes: adjusting display information of the flowchart to display the region of the flowchart including the selected node in the work item detail page.

For example, the region of the flowchart including the selected node is displayed in the work item detail page with the selected node as the center. Alternatively, the region of the flowchart including the selected node is displayed in the work item detail page with the selected node as a start node.

For example, in a case that there is no selected node in the flowchart, a center node of the flowchart is determined, and the flowchart is displayed in the work item detail page based on a preset proportion and the center node. Exemplarily, the center node may be determined based on a center of all nodes across a vertical axis and/or a center of all nodes across a horizontal axis.

With the above embodiment, in a case that the positioning trigger operation for the third control in the process detail page is received, the flowchart can be automatically returned to the target display region to be displayed in the process detail page, such that the flowchart can be quickly positioned. Moreover, positioning manners are distinguished for different situations, such that the response logic is enriched, and the user experience is improved.

In this embodiment, in response to the full-screen viewing operation for the flowchart, the flowchart can be supported to be viewed in full screen in the process detail page. Moreover, node editing and node positioning operations for the flowchart can be supported, and a thumbnail and a full-screen mode can be used in combination, such that a complex project flowchart can be reasonably displayed in complex project information. In this embodiment, although the flowchart occupies a small space in the work item detail page, the flowchart has complete functions, which can facilitate the user to understand a more comprehensive target business process and support more enricheredly information viewing manners.

FIG. 6 is a schematic structural diagram of an apparatus for viewing work item information according to embodiments of the present disclosure. As shown in FIG. 6, the apparatus includes a viewing request module 410 and a page display module 420.

The viewing request module 410 is configured to: in response to a work item viewing request for a target work item, obtain a flowchart of a target business corresponding to the target work item; and the page display module 420 is configured to display at least a partial region of the flowchart in a work item detail page corresponding to the work item viewing request.

In the embodiments of the present disclosure, in response to a work item viewing request for a target work item, a flowchart of a target business corresponding to the target work item is obtained. Compared with a manner of obtaining and displaying only user operation node information in the related art, the obtaining of the flowchart of the target business is added, such that the obtained association information related to the target work item is more comprehensive. At least a partial region of the flowchart is displayed in a work item detail page corresponding to the work item viewing request. The flowchart of the target business can be viewed in the work item detail page, such that the content that can be viewed by the authorized user is increased, and the whole process information associated with the target work item is provided, such that the display form and the display content of the work item information are enrichered, thereby improving the user experience.

In an embodiment, the page display module is configured to:
in a case that there is a pending node corresponding to the authorized user in the flowchart, use at least one pending node as a selected node in the flowchart; and
display a region of the flowchart including the selected node in a first display region in the work item detail page corresponding to the work item viewing request, and display summary information of the selected node in a second display region in the work item detail page.

In an embodiment, the apparatus for viewing work item information further includes:
a linkage update module, configured to, in a case that there are a plurality of pending nodes, in response to a node switching operation for the second display region, switch the summary information of the selected node displayed in the second display region to summary information of another pending node, and update the selected node highlighted in the flowchart to a pending node corresponding to the summary information displayed in the second display region.

In an embodiment, the apparatus for viewing work item information further includes:
a node reset module, configured to receive a reset trigger operation for a first control in the work item detail page, and display a region of the flowchart including the pending node in the first display region and display summary information of the pending node displayed in the first display region in the second display region.

In an embodiment, the apparatus for viewing work item information further includes:
a node summary display module, configured to receive a node selection operation for at least one node in the flowchart, and display summary information of a selected node in the work item detail page.

In an embodiment, the apparatus for viewing work item information further includes:
a display adjustment module, configured to in response to a display adjustment operation for the flowchart, adjust a display manner of the flowchart in the work item detail page, wherein the display manner includes a display size and a display region.

In an embodiment, the apparatus for viewing work item information further includes:
a full-screen viewing module, configured to receive a full-screen viewing operation for the flowchart, and display the flowchart in a process detail page.

In an embodiment, the apparatus for viewing work item information further includes:
a node editing module, configured to receive a node editing operation for a node in the flowchart, and in response to determining that the authorized user has an editing permission, edit the node corresponding to the node editing operation in the flowchart, wherein the node editing operation includes a node deletion operation and a node addition operation.

In an embodiment, the node editing module is configured to:
receive a control trigger operation for a second control in the process detail page, wherein the second control is associated with at least one node in the flowchart; or
receive a node editing trigger operation for at least one node in the flowchart.

In an embodiment, the apparatus for viewing work item information further includes:
a flowchart positioning module, configured to receive a positioning trigger operation for a third control in the process detail page, and display a target display region of the flowchart in the process detail page.

In an embodiment, the target display region includes the region of the flowchart including the selected node;
the apparatus for viewing work item information further includes:
a control display module, configured to before the positioning trigger operation for the third control in the process detail page is received, in a case that there is the selected node in the flowchart and the selected node is not displayed in the work item detail page, display the third control in the process detail page; and
correspondingly, the flowchart positioning module is configured to adjust display information of the flowchart to display the region of the flowchart including the selected node in the work item detail page.

In an embodiment, the apparatus for viewing work item information further includes:
a template update module, configured to receive a template update operation input for the flowchart, obtain an update template corresponding to the flowchart, and update the flowchart based on the update template.

The apparatus for viewing work item information provided in this embodiment of the present disclosure may perform the method for viewing work item information provided in any embodiment of the present disclosure, and has corresponding functional modules and beneficial effects for performing the method.

It is to be noted that the various units and modules included in the above apparatus are divided according to functional logic, but are not limited to the above division, as long as the corresponding functions can be implemented. In addition, the specific names of the functional units are only used to facilitate the distinction between each other, and are not used to limit the protection scope of the embodiments of the present disclosure.

FIG. 7 is a schematic structural diagram of an electronic device according to embodiments of the present disclosure. The following describes an electronic device (for example, the terminal device or the server in FIG. 7) 500 suitable for implementing the embodiments of the present disclosure with reference to FIG. 7. The terminal device in this embodiment of the present disclosure may include, but is not limited to, mobile terminals such as a mobile phone, a notebook computer, a digital broadcast receiver, a personal digital assistant (PDA), a tablet computer (PAD), and a portable media player (PMP), and fixed terminals such as a digital television (TV) and a desktop computer. The electronic device shown in FIG. 7 is merely an example, and shall not impose any limitation on the function and scope of use of the embodiments of the present disclosure.

As shown in FIG. 7, the electronic device 500 may include a processing apparatus (for example, a central processing unit, a graphics processing unit, etc.) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 7 shows the electronic device 500 having various apparatuses, it is to be understood that it is not required to implement or have all of the shown apparatuses. It may be an alternative to implement or have more or fewer apparatuses.

In particular, according to embodiments of the present disclosure, the processes described above with reference to the flowcharts may be implemented as a computer software program. For example, this embodiment of the present disclosure includes a computer program product, which includes a computer program carried on a non-transitory computer-readable medium, wherein the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiments of the present disclosure are performed.

The names of messages or information exchanged between a plurality of apparatuses in the implementation of the present disclosure are used for illustrative purposes only, and are not used to limit the scope of these messages or information.

The electronic device provided in this embodiment of the present disclosure and the method for viewing work item information provided in the above embodiments belong to the same inventive concept. For the technical details not described in detail in this embodiment, reference may be made to the above embodiments, and this embodiment has the same beneficial effects as the above embodiments.

Embodiments of the present disclosure provides a computer storage medium having stored thereon a computer program that, when executed by a processor, implements the method for viewing work item information provided in the above embodiments.

It is to be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. Examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) or a flash memory, an optic fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to electric wires, optical cables, radio frequency (RF), etc., or any suitable combination thereof.

In some implementations, the client and the server may communicate using any currently known or future-developed network protocol such as a hypertext transfer protocol (HTTP), and may be connected to digital data communication (for example, a communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: in response to a work item viewing request for a target work item, obtain a flowchart of a target business corresponding to the target work item; and display at least a partial region of the flowchart in a work item detail page corresponding to the work item viewing request.

The storage medium may be a non-transitory storage medium.

The computer program code for performing the operations in the present disclosure may be written in one or more programming languages or a combination thereof, wherein the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving a remote computer, the remote computer may be connected to the computer of the user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units described in the embodiments of the present disclosure may be implemented by way of software, or may be implemented by way of hardware. The name of a unit does not constitute a limitation on the unit itself in some cases. For example, the viewing request module may alternatively be described as “a module for obtaining a flowchart of a target business”.

The functions described herein above may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. Examples of the machine-readable storage medium may include an electrical connection based on one or more wires, a portable computer disk, a hard disk, a random access memory (RAM), a read-only memory (ROM), an erasable programmable read-only memory (EPROM) or a flash memory, an optic fiber, a portable compact disk read-only memory (CD-ROM), an optical storage device, a magnetic storage device, or any suitable combination thereof.

According to one or more embodiments of the present disclosure, [Example 1] provides a method for viewing work item information, including:
in response to a work item viewing request for a target work item, obtaining a flowchart of a target business corresponding to the target work item; and
displaying at least a partial region of the flowchart in a work item detail page corresponding to the work item viewing request.

According to one or more embodiments of the present disclosure, [Example 2] provides the method according to Example 1, wherein the displaying at least a partial region of the flowchart in a work item detail page corresponding to the work item viewing request includes:
in a case that there is a pending node corresponding to the authorized user in the flowchart, using at least one pending node as a selected node in the flowchart; and
displaying a region of the flowchart including the selected node in a first display region in the work item detail page corresponding to the work item viewing request, and displaying summary information of the selected node in a second display region in the work item detail page.

According to one or more embodiments of the present disclosure, [Example 3] provides the method according to Example 2, wherein the method further includes:
in a case that there are a plurality of pending nodes, in response to a node switching operation for the second display region, switching the summary information of the selected node displayed in the second display region to summary information of another pending node, and updating the selected node highlighted in the flowchart to a pending node corresponding to the summary information displayed in the second display region.

According to one or more embodiments of the present disclosure, [Example 4] provides the method according to Example 2, wherein the method further includes:
receiving a reset trigger operation for a first control in the work item detail page, and displaying a region of the flowchart including the pending node in the first display region and displaying summary information of the pending node displayed in the first display region in the second display region.

According to one or more embodiments of the present disclosure, [Example 5] provides the method according to Example 1, wherein the method further includes:
receiving a node selection operation for at least one node in the flowchart, and displaying summary information of a selected node in the work item detail page.

According to one or more embodiments of the present disclosure, [Example 6] provides the method according to Example 1, wherein the method further includes:
in response to a display adjustment operation for the flowchart, adjusting a display manner of the flowchart in the work item detail page, wherein the display manner includes a display size and a display region.

According to one or more embodiments of the present disclosure, [Example 7] provides the method according to Example 1, wherein the method further includes:
receiving a full-screen viewing operation for the flowchart, and displaying the flowchart in a process detail page.

According to one or more embodiments of the present disclosure, [Example 8] provides the method according to Example 7, wherein the method further includes:
receiving a node editing operation for a node in the flowchart, and in response to determining that the authorized user has an editing permission, editing the node corresponding to the node editing operation in the flowchart, wherein the node editing operation includes a node deletion operation and a node addition operation.

According to one or more embodiments of the present disclosure, [Example 9] provides the method according to Example 8, wherein the method further includes:
the receiving a node editing operation for a node in the flowchart includes:
receiving a control trigger operation for a second control in the process detail page, wherein the second control is associated with at least one node in the flowchart; or
receiving a node editing trigger operation for at least one node in the flowchart.

According to one or more embodiments of the present disclosure, [Example 10] provides the method according to Example 7, wherein the method further includes:
receiving a positioning trigger operation for a third control in the process detail page, and displaying a target display region of the flowchart in the process detail page.

According to one or more embodiments of the present disclosure, [Example 11] provides the method according to Example 10, wherein the method further includes:
the target display region includes the region of the flowchart including the selected node; and before the positioning trigger operation for the third control in the process detail page is received, the method further includes:
in a case that there is the selected node in the flowchart and the selected node is not displayed in the work item detail page, displaying the third control in the process detail page; and
the displaying the target display region of the flowchart in the process detail page includes:
adjusting display information of the flowchart to display the region of the flowchart including the selected node in the work item detail page.

According to one or more embodiments of the present disclosure, [Example 12] provides the method according to Example 1, wherein the method further includes:
receiving a template update operation input for the flowchart, obtaining an update template corresponding to the flowchart, and updating the flowchart based on the update template.

According to one or more embodiments of the present disclosure, [Example 13] provides an apparatus for viewing work item information, including:
a viewing request module, configured to in response to a work item viewing request for a target work item, obtain a flowchart of a target business corresponding to the target work item; and
a page display module, configured to display at least a partial region of the flowchart in a work item detail page corresponding to the work item viewing request.

Those skilled in the art should understand that the scope of disclosure involved in the present disclosure is not limited to the embodiments formed by a specific combination of the above technical features, and should also cover other embodiments formed by any combination of the above technical features or their equivalent features without departing from the above disclosure concept. For example, embodiments formed by replacing the above features with technical features with similar functions disclosed in the present disclosure (but not limited thereto) are also covered.

In addition, although the various operations are depicted in a specific order, it is to be understood as requiring these operations to be performed in the specific order shown or in a sequential order. Under certain circumstances, multitasking and parallel processing may be advantageous. Similarly, although several specific implementation details are included in the foregoing discussion, these details should not be construed as limiting the scope of the present disclosure. Some features that are described in the context of separate embodiments can also be implemented in combination in a single embodiment. In contrast, various features described in the context of a single embodiment can also be implemented in multiple embodiments individually or in any suitable subcombination.

Although the subject matter has been described in a language specific to structural features and/or methodological logical actions, it is to be understood that the subject matter defined in the appended claims is not necessarily limited to the specific features or actions described above. Rather, the specific features and actions described above are merely exemplary forms of implementing the claims.

1. A method for viewing work item information, including:
in response to a work item viewing request for a target work item, obtaining a flowchart of a target business corresponding to the target work item; and
displaying at least a partial region of the flowchart in a work item detail page corresponding to the work item viewing request.

2. The method for viewing work item information of claim 1, wherein displaying the at least a partial region of the flowchart in the work item detail page corresponding to the work item viewing request includes:
in a case that there is a pending node corresponding to the authorized user in the flowchart, using at least one pending node as a selected node in the flowchart; and
displaying a region of the flowchart including the selected node in a first display region in the work item detail page corresponding to the work item viewing request, and displaying summary information of the selected node in a second display region in the work item detail page.

3. The method for viewing work item information of claim 2, further including:
in a case that there are a plurality of pending nodes, in response to a node switching operation for the second display region, switching the summary information of the selected node displayed in the second display region to summary information of another pending node, and updating the selected node highlighted in the flowchart to a pending node corresponding to the summary information displayed in the second display region.

4. The method for viewing work item information of claim 2, further including:
receiving a reset trigger operation for a first control in the work item detail page, and displaying a region of the flowchart including the pending node in the first display region and displaying summary information of the pending node displayed in the first display region in the second display region.

5. The method for viewing work item information of claim 1, further including:
receiving a node selection operation for at least one node in the flowchart, and displaying summary information of a selected node in the work item detail page.

6. The method for viewing work item information of claim 1, further including:
in response to a display adjustment operation for the flowchart, adjusting a display manner of the flowchart in the work item detail page, wherein the display manner includes a display size and a display region.

7. The method for viewing work item information of claim 1, further including:
receiving a full-screen viewing operation for the flowchart, and displaying the flowchart in a process detail page.

8. The method for viewing work item information of claim 1, further including:
receiving a node editing operation for a node in the flowchart, and in response to determining that the authorized user has an editing permission, editing the node corresponding to the node editing operation in the flowchart, wherein the node editing operation includes a node deletion operation and a node addition operation.

9. The method for viewing work item information of claim 8, wherein receiving the node editing operation for the node in the flowchart includes:
receiving a control trigger operation for a second control in the process detail page, wherein the second control is associated with at least one node in the flowchart; or
receiving a node editing trigger operation for at least one node in the flowchart.

10. The method for viewing work item information of claim 7, further including:
receiving a positioning trigger operation for a third control in the process detail page, and displaying a target display region of the flowchart in the process detail page.

11. The method for viewing work item information of claim 10, wherein the target display region includes the region of the flowchart including the selected node; and
before the positioning trigger operation for the third control in the process detail page is received, the method further includes:
in a case that there is the selected node in the flowchart and the selected node is not displayed in the work item detail page, displaying the third control in the process detail page; and
the displaying the target display region of the flowchart in the process detail page includes:
adjusting display information of the flowchart to display the region of the flowchart including the selected node in the work item detail page.

12. The method for viewing work item information of claim 1, further including:
receiving a template update operation input for the flowchart, obtaining an update template corresponding to the flowchart, and updating the flowchart based on the update template.

13. (canceled)

14. An electronic device, including:
one or more processors; and
a storage configured to store one or more programs,
wherein the one or more programs, when executed by the one or more processors, cause the one or more processors to:
in response to a work item viewing request for a target work item, obtain a flowchart of a target business corresponding to the target work item; and
display at least a partial region of the flowchart in a work item detail page corresponding to the work item viewing request.

15. A non-transitory storage medium containing computer-executable instructions, wherein the computer-executable instructions, when executed by a computer processor, cause the computer processor to:
in response to a work item viewing request for a target work item, obtain a flowchart of a target business corresponding to the target work item; and
display at least a partial region of the flowchart in a work item detail page corresponding to the work item viewing request.

16. The electronic device of claim 14, wherein the one or more programs that cause the one or more processors to display the at least a partial region of the flowchart in the work item detail page corresponding to the work item viewing request include instructions to:
in a case that there is a pending node corresponding to the authorized user in the flowchart, use at least one pending node as a selected node in the flowchart; and
display a region of the flowchart including the selected node in a first display region in the work item detail page corresponding to the work item viewing request, and display summary information of the selected node in a second display region in the work item detail page.

17. The electronic device of claim 14, the one or more processors is further caused to:
receive a full-screen viewing operation for the flowchart, and display the flowchart in a process detail page.

18. The electronic device of claim 14, the one or more processors is further caused to:
receive a template update operation input for the flowchart, obtain an update template corresponding to the flowchart, and update the flowchart based on the update template.

19. The non-transitory storage medium of claim 15, wherein the computer-executable instructions that cause the computer processor to display the at least a partial region of the flowchart in the work item detail page corresponding to the work item viewing request include instructions to:
in a case that there is a pending node corresponding to the authorized user in the flowchart, use at least one pending node as a selected node in the flowchart; and
display a region of the flowchart including the selected node in a first display region in the work item detail page corresponding to the work item viewing request, and display summary information of the selected node in a second display region in the work item detail page.

20. The non-transitory storage medium of claim 15, the computer processor is further caused to:
receive a full-screen viewing operation for the flowchart, and display the flowchart in a process detail page.

21. The non-transitory storage medium of claim 15, the computer processor is further caused to:
receive a template update operation input for the flowchart, obtain an update template corresponding to the flowchart, and update the flowchart based on the update template.
